(19) United States
(12) Patent Application Publication
(10) Pub. No.: US 2012/0122595 A1
(43) Pub. Date: May 17, 2012

(54) DRIVE MECHANISM FOR TRANSMITTING ROTATIONAL TORQUE

(76) Inventor: Ion Stanomir, Edmonton (CA)

(21) Appl. No.: 12/947,988

(22) Filed: Nov. 17, 2010

(51) Int. Cl. F16D 3/26

(52) U.S. Cl. 464/155

(57) ABSTRACT

A drive mechanism for transmitting rotational force including a drive member for applying the rotational force and a driven member to be turned by the drive member. One of the members has a socket forming an internal oval female contact surface and the other member has an end forming an external, circumferential, oval male contact surface dimensioned to be received in and to engage the female contact surface for the transmission of the rotational force.

### TECHNICAL FIELD

The present invention relates to a drive mechanism for transmitting rotational torque and to a drive shaft for use as part of the drive mechanism.

### BACKGROUND

The invention was initially developed in the context of improving on a drive shaft assembly employed in an oilfield drilling tool referred to as a bent sub. The invention is contemplated to have other applications—however the general nature of such a drive shaft assembly and the problem addressed in connection therewith is now described.

In one known bent sub (a), illustrated in FIG. 1, rotational force or torque and downwardly directed drill string thrust or axial load are transmitted from the rotating output power section of a downhole drilling motor (not shown) to the bent sub's drive shaft (b) through a drive mechanism (c). It will be noted that the drive mechanism incorporates an adapter (d), connected when in operation with the motor power section. The lower end of the adapter forms an internal socket (e) having a slotted surface (f) and curved seat (g). The bent sub drive shaft has a rounded end or head (h); the head forms semi-circular cavities (i) which are positioned to correspond with the slots of the adapter. The adapter and head are coupled for rotation together by spherical balls (j) (known as ‘rock bit balls’), positioned in the corresponding rounded cavities and slots.

This arrangement has the following characteristics. By utilizing a complementary rounded seat and shaft head, the assembly enables downward thrust transmission while permitting some tilting of the shaft relative to the adapter. The ball and slot coupling arrangement therefore accommodates downward thrust transmittal and shaft tilting, while also enabling transmission of rotary torque.

However, the utilization of such a drive mechanism, comprising adapter, ball and slot coupling and shaft head, for transmitting torque necessarily limits the contact area of the torque transmitting surfaces. As a consequence, the stress at the contact surfaces is concentrated and high.

It needs to be understood that bent subs and their components operate in a very harsh environment. It typically involves very large downward loading arising from the drill string, cyclic loads, impact loads, exposure to abrasive fluids, elevated temperature and corrosion. These factors, coupled with the high contact stress, can lead to early component failure.

One solution for increasing contact area and thereby diminishing stress would be to simply increase the size of the components. However this option is limited in the drilling tool art by the fact that the borehole diameter dictates the size of the mechanical devices used in it.

Therefore, in the drilling tool art there has long existed a need for increasing the contact surface area of drive mechanisms used to transmit rotational torque, without significantly changing the external dimensions of the mechanism. The present invention addresses this specific need. However it is contemplated that the solution that was developed will also find application in other drive mechanism contexts.

### SUMMARY OF THE INVENTION

The present invention is directed to providing a drive connection or mechanism having contact surfaces, for transmission of rotational torque, which are larger in area when compared, for example, with the previously described ball and slot coupling. The drive mechanism further is designed to use fewer components in comparison to the prior art ball and slot coupling.

In accordance with one aspect of the invention, a drive member (such as an adapter) is connected with a driven member (such as a drive shaft) for the transmission of rotational force or torque therebetween by a drive mechanism that utilizes a pair of mating, engaged, oval contact surfaces to transmit the torque.

In a preferred embodiment, the drive mechanism utilizes a socket, at the end of one member, forming an internal oval female contact surface. The socket is adapted to receive and drivably engage an end of the other member, which forms a complementary external oval male contact surface. The two contact surfaces are dimensioned to have a close fit and mate so that they contact and engage over substantially their entire respective internal and external circumferences for the transmission of rotational torque.

In accordance with another aspect of the invention, a drive shaft is provided having one or both ends circumscribed by an external, oval male contact surface, for transmitting rotational torque. In a preferred embodiment, the shaft is cylindrical and rounded at each end and is circumscribed by a protruding ring forming the external oval male contact surface. In an optional feature, the male contact surface may have a transverse radius to accommodate tilting of the shaft. In another optional feature, each rounded shaft end extends beyond its ring to provide a contact surface for transmitting thrust while permitting tilting of the shaft.

### DESCRIPTION OF THE DRAWINGS

FIG. 1 is a sectional side view of a bent sub having a drive mechanism incorporating ball-and-slot means for transmitting rotary torque from a downhole motor power section to a drive shaft, in accordance with the prior art;

FIGS. 2-10 illustrate, by way of example, in the context of a bent sub drive shaft and adapter, one embodiment of the invention. More specifically:

FIG. 2 is a sectional side view of a bent sub drive shaft having an externally protruding oval ring, integral with and circumscribing the end of the shaft, each ring forming an oval male contact surface having a transverse radius;

FIG. 3 is an end view of one end of the shaft of FIG. 2;

FIG. 4 is a cross-section of the ring along the line A-A; FIGS. 3 and 4 illustrate the spherical nature of the shaft end and the oval nature of the ring and its contact surface;

FIG. 5 is a sectional side view of an adapter for transmitting thrust and rotary torque to one end of the shaft of FIG. 2, the adapter having a socket at its lower end forming a spherical cavity for receiving and contacting the end of the shaft for the transmittal of axial thrust and an internal oval contact surface for engaging the shaft's external contact surface for transmitting rotational torque;

FIG. 6 is an end view of the socket of FIG. 5, illustrating the spherical nature of the cavity and the oval nature of its rotary torque contact surface;

FIG. 7 is a side view showing the drive shaft of FIG. 2 coupled with the adapter of FIG. 5 at one end of the shaft;

FIG. 8 is a sectional view of the assembly of FIG. 7;

FIG. 9 is a sectional view of the drive mechanism of the assembly of FIG. 7; and

FIG. 10 is a sectional view taken along the line B-B of FIG. 9, illustrating the engaged contact surfaces of the drive mechanism.

### DETAILED DESCRIPTION OF THE ILLUSTRATED EMBODIMENT

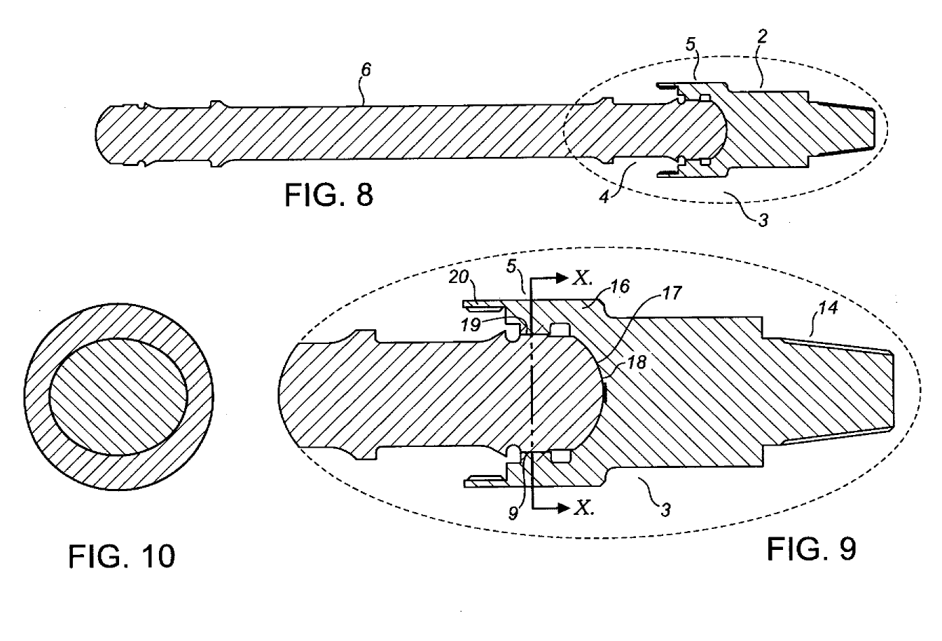

FIGS. 7-10 show a bent sub drive shaft 1 and an adapter 2, coupled for the transmission of downward thrust and rotational torque by a drive mechanism 3. The drive mechanism 3 comprises the upper end 4 of the drive shaft 1 and the lower end 5 of the adapter 2.

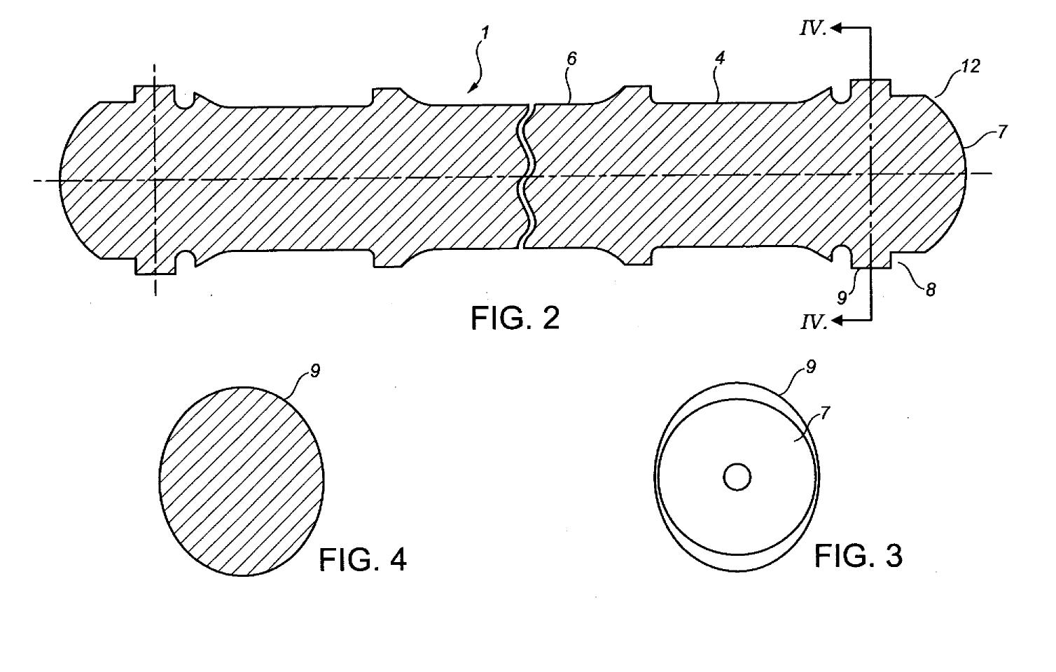

In greater detail, and having regard to FIGS. 2-4, the drive shaft 1 has a central portion 6 terminating at each end 12 with a spherical thrust contact surface 7. Each shaft end 12 is circumscribed by an integral, outwardly protruding ring 8 forming an external, continuous, oval male contact surface 9. The contact surface 9 has a radius.

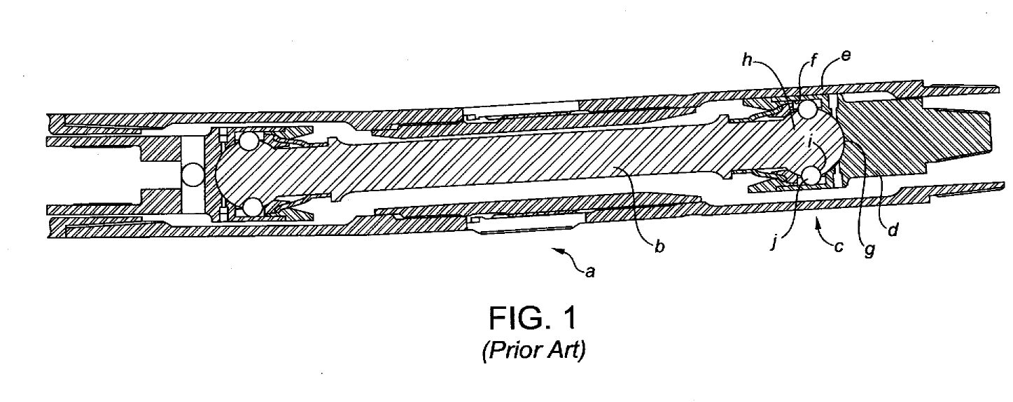

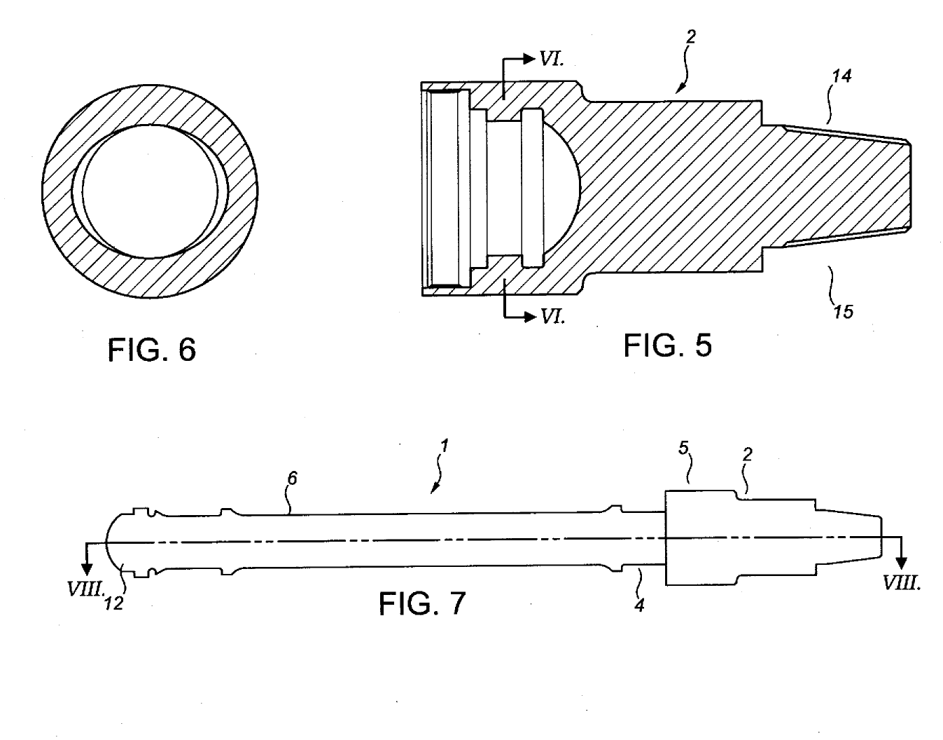

Having reference to FIGS. 5 and 6, the adapter 2 has an internally threaded coupling 14 at its upper end 15, for connection to the power section of a downhole drilling motor (not shown). At its lower end 5 it has a socket 16. The socket 16 forms a spherical cavity 17 having a contact surface 18. The cavity 17 is suitably dimensioned to receive, contact and provide a seat for the spherical thrust contact surface 7 of the shaft upper end 12. The socket 16 further forms an internal, oval female contact surface 19 suitably dimensioned to receive, contact and drivably engage the oval male contact surface 9 of the drive shaft 1. The female contact surface 19 has a radius corresponding with the radius of the male contact surface 9 (see FIG. 10). The adapter 2 terminates at its lower end 5 with an internally threaded collar 20 for connecting the adapter 2 with the drive shaft 1 using known means such as the split boot ring, boot ring and rubber boot shown in prior art FIG. 1.

In use and turning to FIG. 9, the shaft upper end 12 is received in the adapter socket 16. The shaft's spherical thrust contact surface 7 seats in and contacts the adapter's spherical contact surface 18, for enabling downward transmission of axial load from the adapter 2 to the shaft 1 through contact surfaces 7, 18, while permitting limited tilting of the shaft 1 relative to the adapter 2. The shaft end's oval, radiused male contact surface 9 contacts and engages the adapter's oval, radiused female contact surface 19, enabling transmission of rotational torque therebetween while accommodating limited tilting of the shaft 1 relative to the adapter 2.

### ALTERNATIVE APPLICATIONS

As previously mentioned, it is contemplated that the provision of a drive mechanism having mating engaged oval contact surfaces can advantageously be used to transmit rotational torque in applications other than a bent sub context. For example, such a drive mechanism could be implemented in an automobile drive train.

The scope of the invention is defined in the claims now following.

What is claimed:

1. A drive mechanism for transmitting rotational force, comprising:
a drive member for applying the rotational force; and
a driven member to be turned by the drive member;
one of the drive and driven members having a socket forming an internal oval female contact surface;
the other of the drive and driven members having an end forming an external, circumferential, oval male contact surface dimensioned to be received in and to engage the female contact surface for the transmission of the rotational force.

2. The drive mechanism as set forth in claim 1, wherein at least one of the contact surfaces has a transverse radius.

3. The drive mechanism as set forth in claim 2, wherein:
the drive member is a bent sub adapter having the socket forming the female contact surface; and
the driven member is a bent sub drive shaft having the end forming the male contact surface.

4. The drive mechanism as set forth in claim 1, wherein each of the contact surfaces has a transverse radius and the radii of the contact surfaces correspond so as to enable tilting of one of the drive and driven members relative to the other of the drive and driven members when the contact surfaces are engaged.

5. The drive mechanism as set forth in claim 4, wherein:
the drive member is a bent sub adapter having the socket forming the female contact surface; and
the driven member is a bent sub drive shaft having the end forming the male contact surface.

6. The drive mechanism as set forth in claim 1, wherein:
the drive member is a bent sub adapter having the socket forming the female contact surface; and
the driven member is a bent sub drive shaft having the end forming the male contact surface.

7. A drive shaft to be rotationally driven, comprising:
a shaft having first and second ends;
a ring protruding externally from and circumscribing the shaft's first end, the ring forming an external, circumferential, oval male contact surface for the transmission of rotational force; and
means at the shaft's second end for transmitting the rotational force to the shaft.

8. The drive shaft as set forth in claim 7, wherein:
the male contact surface has a transverse radius.

9. The drive shaft of claim 8, wherein:
the means at the second end of the shaft comprises a rounded end having a ring protruding externally therefrom, the ring forming an external, circumferential, oval male contact surface for the transmission of rotational force.

10. The drive shaft as set forth in claim 8, wherein:
the first end of the shaft extends beyond the ring and is rounded.

11. The drive shaft of claim 10, wherein:
the means at the second end of the shaft comprises a rounded end having a ring protruding externally therefrom, the ring forming an external, circumferential, oval male contact surface for the transmission of rotational force.

12. The drive shaft as set forth in claim 7, wherein:
the first end of the shaft extends beyond the ring and is rounded.

13. The drive shaft of claim 12, wherein:
the means at the second end of the shaft comprises a rounded end having a ring protruding externally therefrom, the ring forming an external, circumferential, oval male contact surface for the transmission of rotational force.

14. The drive shaft as set forth in claim 7, wherein:
the means at the second end of the shaft comprises a rounded end having a ring protruding externally therefrom, the ring forming an external, circumferential, oval male contact surface for the transmission of rotational force.
